(19) United States
(12) Patent Application Publication
(10) Pub. No.: US 2017/0320142 A1
(43) Pub. Date: Nov. 9, 2017

(54) Cutting tool with chip breaker as well as manufacturing process for production of this cutting tool

(71) Applicant: Jakob Lach GmbH & Co. KG, Hanau (DE)

(72) Inventor: Horst LACH, Hanau (DE)

(73) Assignee: Jakob Lach GmbH & Co. KG, Hanau (DE)

(21) Appl. No.: 15/147,972

(22) Filed: May 6, 2016

(51) Int. Cl. B23B 27/14; B33Y 80/00; B33Y 10/00

(52) U.S. Cl. CPC B23B 27/143; B23B 2228/10; B23B 2226/315; B23B 2226/12; B33Y 10/00; B23B 2200/0447; B33Y 80/00; B23B 2200/321

(57) ABSTRACT

A cutting tool with a device for the prevention of uncontrolled chip formation which are placed in a specific distance to a cutting edge at a layer of polycrystalline diamond (PCD) or polycrystalline boron nitride (PCBN), and to a manufacturing process for the production of such a cutting tool. The PCD or PCBN layer incorporates the device for the prevention of uncontrolled chip formation as an integral part, and the layer with the device for the prevention of uncontrolled chip formation and the cutting edge are produced by way of an additive procedure, or that the device and the cutting edge are produced by removing material of the PCD or PCBN body by laser or electro-erosion.

The present invention relates to a cutting tool with means for the prevention of uncontrolled chip formation which are placed in a specific distance to a cutting edge at a layer of polycrystalline diamond (PCD) or polycrystalline boron nitride (PCBN) and to a manufacturing process for the production of such a cutting tool.

During machining of particularly tough materials, e. g. nonferrous metals or plastics, the objective is to avoid the uncontrolled formation of long chips because these chips can damage the machined surfaces or other components. So-called chip breakers, which break the chips to shorter lengths, and chip grooves, which divert the long chips from the work area, are commonly known. Because such means for the prevention of uncontrolled chip formation should be placed as close as possible to the cutting edge in order to be effective, cutting tools with PCD or PCBN cutting materials run into the problem that the PCD or PCBN layer creates the cutting surface to which separate means cannot be attached reliably. One workaround is to solder the cutting tools into a slot of a tool holder; however, this method will only allow for a soldering connection between the supporting body and the slot, leaving a small gap between the surface of the PCD or PCBN layer and the means for chipping control. Experience shows that chips can get stuck in this gap resulting in either the tool holder wearing down quickly or damage to the material surfaces.

EP 1 023 962 A1 describes a diamond cutting tool with a chip breaking function with a hard metal guiding system soldered to the base layer through an opening in the PCD or PCBN layer which creates a protrusion together with the upward-sloped guide surface behind the cutting edge above the diamond layer.

Furthermore, EP 2 067 552 A1 describes a cutting tool for machining of workpieces, in particular, workpieces made of nonferrous metals or plastics which feature a cutting edge and adjacent surface made out of a base layer of hard metal joined to an ultra-hard layer of monocrystalline or polycrystalline diamond or polycrystalline boron nitride. The cutting surface creates, behind the cutting edge in the ultra-hard layer (14), an angular or concave rounded slope, a base and a depression with a depth of 0.1 to 0.5 mm below the level of the cutting edge. In order to improve the cutting process, it is the intention that the ultra-hard layer will be carved out down to the supporting layer immediately behind the incline of the depression and then a guiding system will be soldered or glued onto the base layer so that it protrudes over the ultra-hard layer and is equipped with a slanting or concave rounded guide surface which will be adjacent to the part of the cutting surface which forms the incline of the depression.

All known embodiments feature hard metal means for the prevention of uncontrolled chip formation and must be produced in a special step and then be connected with the base.

This invention aims to design a cutting tool with PCD or PCBN cutting material which will allow placement of the means for chip control the chip cutting surface near the cutting edge without a gap and which can be produced in a simple manner.

This task is accomplished according to the present invention so that the PCD or PCBN layer contains all chip controlling means as an integral part and that the means for the prevention of uncontrolled chip formation will be created via additive procedures or removing material from the ultra-hard layer by electro-erosion or laser.

Developing the means for the prevention of uncontrolled chip formation as an integral part of the PCD or PCBN layer allows for precise positioning of the sides of the means to the cutting edge to a more specific distance; this would not be possible if the layer was produced separately. Precise adherence to about 0.25 to 1.5 mm distance of the means for the prevention of uncontrolled chip prevention will not increase the danger of brittle fractures in the very damageable cutting materials.

Another advantage of the invention is that this cutting tool can be manufactured in a very cost-effective way by using either an additive procedure like 3D printing of the cutting material or by separating the cutting material on the supporting body and removing material of the ultra-hard cutting material by means of electro-erosion or laser. Any shape of chip controlling means can be formed.

Since the means for the prevention of uncontrolled chip formation are an integral part of the cutting tool, a very strong bond of said means is possible. The sides or cutting faces of the means for the prevention of uncontrolled chip formation can be positioned in immediate proximity to the cutting edge which will allow for the formation of relatively high chip breaking or chip guiding means should this be requested.

The thickness of the PCD or PCBN cutting tool will preferably be between approximately 0.5 to 3 mm, while the cutting edge will preferably be between 0.25 and 0.77 mm and the means for the prevention of uncontrolled chip formation should be between approximately 0.25 to 0.75 mm. These kind of layer thicknesses can be achieved with currently known manufacturing procedures for cutting tools.

The inventive cutting tool can be used as an insert for a mount or indexable insert with several cutting edges.

Depending on the type of use and cutting material, the means for the prevention of uncontrolled chip formation can be formed either as a chip groove for diverting chips or as a chip breaker for shortening chips to a non-hazardous length.

As a chip breaker, it will expediently protrude 0.25 to 2 mm over the upper border of the cutting edge and will be approximately beveled 40° to 50° at the flank which faces the cutting edge. Alternatively or in addition to the beveling, the upper edge of the chip breaker, which is facing the cutting edge, can be rounded off with a radius of 0.5 mm for example.

It is evident that the inventive cutting tool, in all its possible embodiments, can be formed as a drilling, milling, or turning tool.

Further details, advantages and characteristics of the invention derive not only from requirements, and the characteristics following from those requirements—both individually and in combination, but also from the below-listed descriptions of preferred design examples illustrated in attached figures.

Illustrations show:

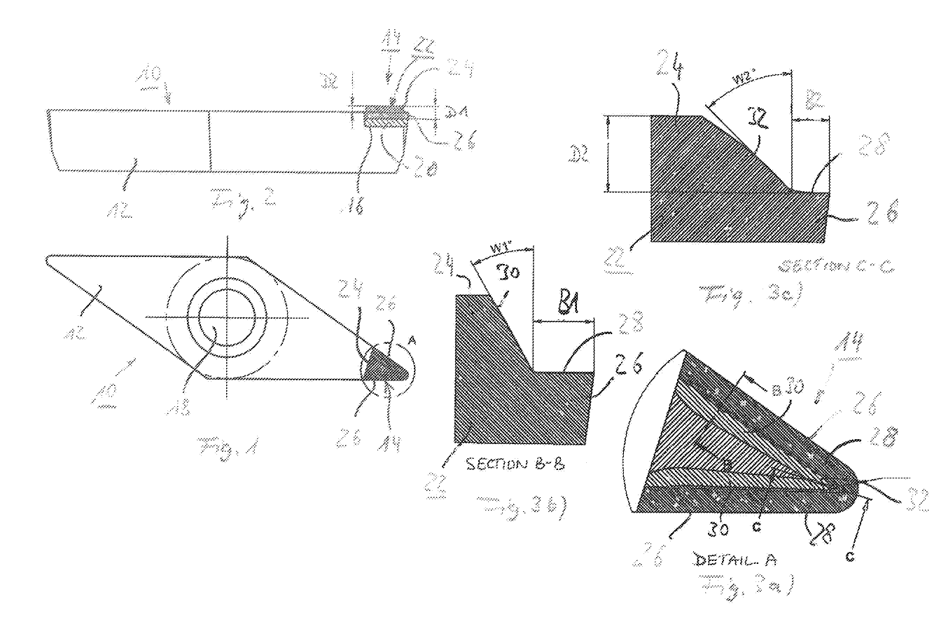

FIG. 1 top view of a tool;

FIG. 2 longitudinal cut of the tool in FIG. 1;

FIG. 3a segment A from FIG. 1 on a larger scale;

FIG. 3b vertical cross section according to line B-B in FIG. 3a);

FIG. 3c vertical cross section according to line C-C in FIG. 3a);

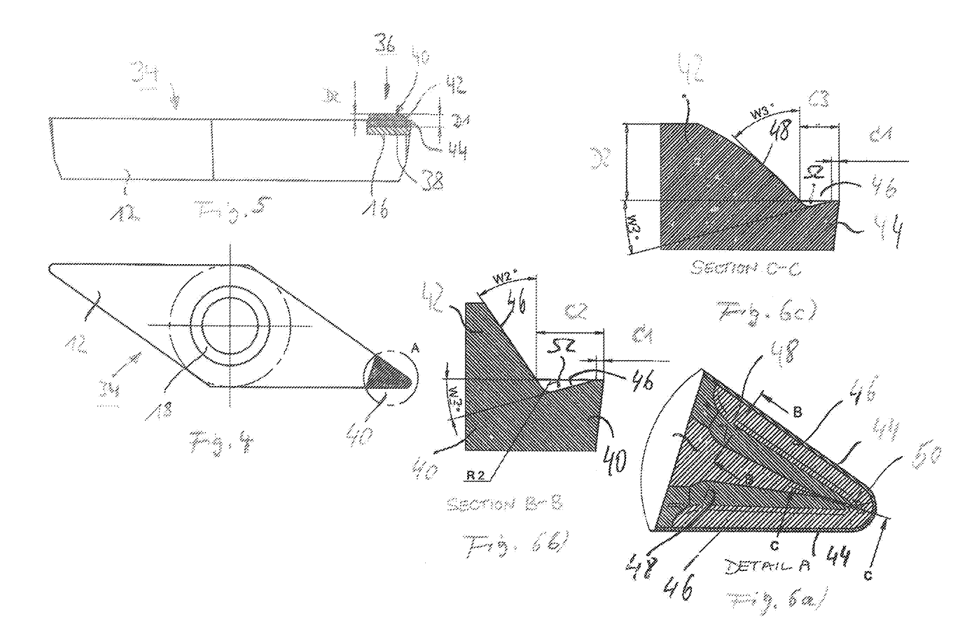

FIG. 4 top view on another tool model with chip breaker;

FIG. 5 longitudinal section of the tool in FIG. 4;

FIG. 6a segment A from FIG. 4 on a larger scale;

FIG. 6b vertical cross section according to line B-B in FIG. 6a);

FIG. 6c vertical cross section according to line C-C in FIG. 6a).

FIGS. 1 and 2 show a top view and a longitudinal cut of tool 10 which consists essentially of holder 12 and cutting tool insert 14. The cutting tool insert 14 is seated in a correspondingly-shaped opening 16 at the end of holder 12, which has a center fastening hole 18, allowing for precise attachment of tool 10 to another holder (not shown).

The cutting tool insert 14 basically consists of support base 20 and layer 22 applied on top of supporting body 20 consisting of polycrystalline diamond (PCD) and chip breaker 24 and cutting edge 26 as integral parts. The supporting base 20 is soldered onto space 16 so that the cutting tool insert 14 is tightly bonded to holder 12.

The production of cutting tool insert 14 is performed in such a way that the PCD layer 22 is attached to supporting body 20 with a thickness D which in this case is 1 mm. In addition to conventional methods, it would also be conceivable to apply the diamond material onto supporting body 20 by an additive procedure.

Subsequently, chip breaker 24, as well as cutting edges 26, can be formed by removing material from layer 22 via countersink eroding or laser or another eroding or vaporization procedure.

FIG. 3a)-3c) show in detail a top view as well as sectional views of cutting edges 26 with adjacent chip breaker 24 which protrudes over surface 28 of the cutting edge. The side edges of chip breaker 24 are parallel to cutting edge 26 and one tip of the chip breaker is rounded according to the tip of cutting edge 26. Surface 28 of cutting edge 26 forms a bridge-like, essentially flat, cutting surface which will transitions seamlessly into flanks 30, 32 of chip breaker 24. Flanks 30 within the area of the lateral cutting edges 26 along line B-B are beveled at an angle W of approximately 300 and flank 32 in the area of the front tip of cutting edge 26 along line C-C is beveled at an angle W2 of approximately 450. While flanks 30 within the area of lateral cutting edges 26 show a flat surface, flank 32 within the area of the tip is formed with a convex surface.

The surface of cutting edges 26 of cutting tool insert 14 forms a bridge with a width B1 along the line B-B of approximately 0.4 to 0.6 mm and a width B2 along the line C-C of approximately 0.25 to 0.45.

During machining, flanks 30 and 32 in immediate proximity of the cutting surface of chip breaker 24 provide for an early breaking of chips so that no long chips will be formed. The integral formation of cutting tool 14 with cutting edges 26 and chip breaker 24 provide for a good force transmission into supporting body 20 without any significant bending moments. In particular, no gap will be formed between chip breaker 24 and the remaining PCD material so that the danger of chips entering into the gap is eliminated.

FIG. 4 to 6 show another tool 34 with holder 12 which corresponds to the holder of tool 10 illustrated in FIGS. 1 and 2. Cutting tool insert 36 is soldered into opening 16 and consists mainly of a PCD layer 40 attached to supporting body 38 with chip breaker 42 and cutting edge 44 as integral parts. PCD layer 40 corresponds to the dimensions of cutting tool insert 14 in FIGS. 1 and 2.

As apparent from FIG. 6a)-6c), chip breaker 42 protrudes upwardly over surface 46 of cutting edge 44. Its side surfaces 48 and 50 and the plane of cutting edge 44 form an angle W2 of 30° for example along line B-B or an angle W3 of 45° for example along line C-C. While lateral surfaces 48 run along the lateral cutting edges 44, the lateral surface 50 along line C-C in the tip of the cutting tool insert 36 is formed convex.

A relatively small depression 52 in surface 46 of diamond layer 40 is used for the cutting tool for fine finishing, illustrated in FIG. 6a)-6c), between cutting edge 44 with a width C1 of approximately 0.02 mm and chip breaker 42. In the embodiment provided in the example, along line B-B it has a width C2 in the range of 0.4 to 0.6 mm and along line C-C a width C3 in the range of 0.25 to 0.45 mm. Angle W3 of cutting surface 52 from cutting edge 44 into the depression 52 is for example, as specified, 15° or for example 20-25°.

Depending on application, e. g. in particular for machining harder materials, the layers attached to the supporting bodies for the formation of chip breaker and cutting edges can also be made of polycrystalline PCB, also known as CBN.

It is possible to mount the inventive arrangement of means for chip control onto composite panels, e.g. cutting inserts, in which case separate holders would not be necessary.

Chip and clearance angles can be modified independent of the arrangement of chip breakers of each cutting tool. Such modified cutting tool inserts are suitable for use in drilling and milling as well as in turning tools.

The present invention also includes the problem of developing a manufacturing process for the production of a cutting tool insert with means for the prevention of uncontrolled chip formation; the means are arranged in the area of a cutting surface and in a specific distance to a cutting edge at a layer of polycrystalline diamond (PCD) or polycrystalline boron nitride (PCBN) and preferably arranged on top of a supporting body.

In order to solve this problem, the invention provides essentially for the layer of PCD or PCBN and the means for the prevention of uncontrolled chip formation to be formed as an integral part, while the layer with the means for the prevention of uncontrolled chip formation and the cutting edge are manufactured with an additive procedure or while the means for the prevention of uncontrolled chip formation and the cutting edge are produced by removing material of the PCD or PCBN body via laser or electro-erosion.

The invention also provides that at least part of the component with modified properties, in this case the layer with the means for the prevention of uncontrolled chip formation and the cutting edge, will be manufactured with an additive procedure including pourable or flowable materials which include particles of ultra-hard materials such as diamond and/or CBN. In particular, a manufacturing procedure for a tool for milling, grinding, deburring, cutting, or dressing consisting of a body such as a tool or supporting body, with at least one working part containing diamond and/or CBN or made of diamond and/or CBN, is envisioned. This procedure distinguishes itself by producing the working part through a generative manufacturing method during which pourable and/or flowable material consisting of or containing matrix particles of metals and/or ceramics as well as diamond and/or CBN particles is applied to the body.

The pourable or flowable material can be cohesive or non-cohesive material, i.e. free flowing bulk materials.

Additive or generative manufacturing procedures, also known as 3D printing procedures, are automated procedures during which repetitive layer processes are used. Typically the process begins with a three-dimensional CAD data set which models the component to be manufactured. Typically the data set is generated via 3D CAD construction (CAD), scanning or imaging procedures such as computer tomography.

Independent of how the 3D data set is generated, the first step is performed with a computer and special software and cuts the part into discs or layers based on the 3D data set so that a set of contoured virtual layers will be generated which will not necessarily, but preferably, have a uniform width. Next, the data set consisting of contour data, layer thickness and layer number will be transmitted to a machine in order to generate the part.

There is also the possibility to add materials for the manufacturing of the part immediately within the area where the laser beam will hit, so that material is conserved since only as much material is needed as is melted or sintered for the production of the part.

Preferably it is suggested to produce the part by laser sintering or melting, selective laser melting procedure in particular. Pourable and/or flowable materials can be provided in layers or added via a nozzle to the area where the laser beam will hit. The pourable and/or flowable materials used should contain matrix particles of metal or ceramics.

According to the invention, a part or an area with modified as well as abrasive properties will be produced in a generative manufacturing procedure so that even working parts like cutters or cutting bodies are available in high geometrical complexity; traditional procedures cannot produce such complexity, unless by means of extensive and cost intensive measures.

Brake discs, brake pads or clutches are also conceivable as possible components, which could all be produced in a generative, also additive, procedure, while at least the modified areas with a higher hardness contain diamond and/or CBN particles which are fixated in the melted-on or sintered matrix material. Thereby the possibility exists to produce the entire component or only the area with modified properties via an additive procedure. The same applies for other components produced according to the inventive procedure; in particular, tools like milling, grinding, deburring, cutting, or dressing tools.

A powder is used which is made of matrix particles, metal particles in particular, and of diamond and/or CBN particles.

In particular it is provided that the diamond or CBN particles are mixed with the matrix particles in the form of a granulate or powder. In the process the diamond or CBN particles can have a grit size between 0.1 μm and 6 μm or more for example 1.300 μm, while the specific grit size is given as at least 50%, particularly for at least 70%, especially preferred for at least 90% of the diamond or CBN particles.

The size of the diamond or CBN particles must be such that when the powder consisting of matrix particles and the diamond and/or CBN particles is applied with a nozzle, the nozzle will have a high flow rate.

The diamond and/or CBN particles used must allow for a sorted or unsorted grit size.

It is intended that the matrix particles, in particular, the metal particles, have a medium grit size between 1 μm and 200 μm, while the preferred optimum is between 10 μm and 20 μm. Hard metal is especially suitable for the metal particles. Suitable ceramic materials withstand heat caused by the laser beam. An example is zirconium oxide.

Preferably, the size of the matrix particles should be the same as the size of the diamond and CBN particles.

In particular, the invention provides that the pourable and/or flowable material will be provided in layers while each layer will be exposed successively to the energy of a laser beam intended for sintering or melting, while the energy-impacted areas will form the desired geometry of the cutting body.

Alternatively, it is intended to add the pourable and/or flowable material radially while the pourable or flowable material is supplied to the area impacted by the laser beam.

The component can be manufactured on a support, insofar as it is produced according to the additive procedure. After production, it is removed from the support. Alternatively, there is the possibility to use the additive method exclusively for areas of the proposed component where modified properties are required. For this purpose, the layers, or rather the material, will be applied to the base of the component in which the modified properties are to be formed.

Consequently, the pourable and/or flowable material can be applied in layers onto at least one area of the component base or be applied radially in the area impacted by the laser beam.

A component with an abrasive area, containing at least diamond and/or CBN, will be characterized by the fact that at least the abrasive area is produced by a generative manufacturing procedure with pourable and/or flowable materials—containing or made of matrix particles of the metal/ceramic particle group as well as diamond and/or CBN particles. In the process, previously described procedural measures can be applied. When referring to an abrasive area where cutting, deburring and grinding or machining is done or which shows tribological properties, the term modified area or working part also includes wear-protection materials.

It is within the range of this invention, if the component is produced with an additive or generative manufacturing procedure, and in which the composition of the materials in the area showing modified surface properties are different from the other areas of the component. However, the component can be made completely of a material which has the same composition.

1. Cutting tool insert (14, 36) with means (24, 42) for the prevention of uncontrolled chip formation arranged in a specific distance to the cutting edge (26, 44) at a layer (22, 40) of polycrystalline diamond (PCD) or polycrystalline boron nitride (PCBN) within the area of a cutting surface (28, 46), and preferably arranged on a supporting body (20, 38), wherein said PCD or PCBN layer (22, 40) incorporates the means (24, 42) for the prevention of uncontrolled chip formation as an integral part and wherein said layer (22, 40) with said means (24, 42) for the prevention of uncontrolled chip formation and said cutting edge (26, 44) are produced by way of an additive procedure or that said means (24, 42) for the prevention of uncontrolled chip formation and said cutting edge (26, 44) are produced by removing material of the PCD or PCBN body by laser or electro-erosion.

2. Cutting tool insert according to claim 1, wherein said the means for the prevention of uncontrolled chip formation are formed as chip breaker (24; 42).

3. Cutting tool insert according to claim 1, wherein said guide surface (30, 32; 46, 48) of the chip breaker (24, 42) in relation to said plane of cutting edge (26, 44) will show an ascending slope of 30 to 60°.

4. Cutting tool insert according to claim 1, wherein said cutting surface (46) behind said cutting edge (44) creates an angular or concave rounded slope, a bottom base and an increase of a depression (52) with a depth of 0.1 to 0.5 mm below the level of said cutting edge (44).

5. Cutting tool insert according to claim 1, wherein said means (24, 42) for the prevention of uncontrolled chip formation protrudes over said cutting surface (28, 46) and is equipped with an angular or convex rounded guide surface (30, 32; 46, 48) which connects to said cutting surface (28) or the part of the cutting surface (46) which forms the increase of the depression (52).

6. Cutting tool insert according to claim 1, wherein said cutting tool is formed as a drilling, milling, or turning tool.

7. Cutting tool insert according to claim 1, wherein said cutting tool is formed as an insert (14, 36) for a holder (12) or as an indexable insert with multiple cutting edges.

8. Procedure for the manufacturing of a cutting tool insert (14, 36) with means (24, 42) for the prevention of uncontrolled chip formation arranged within the area of a cutting surface (28, 46) and in a specific distance to a cutting edge at layer (22, 40) of polycrystalline diamond (PCD) or polycrystalline boron nitride (PCBN), and preferably arranged on top of a supporting body (20, 38), wherein said PCD or PCBN layer (22, 40) and said means (24, 42) for the prevention of uncontrolled chip formation are formed as integral parts whereby layer (22, 40) with said means (24, 42) for the prevention of uncontrolled chip formation and said cutting edge (26, 44) are produced by way of an additive procedure and whereby said means (24, 42) for the prevention of uncontrolled chip formation and cutting edge (26, 44) are produced by removing material of the PCD or PCBN body by laser or electro-erosion.

9. Procedure according to claim 8, wherein said layer (22, 36) is produced by an additive procedure and with the use of pourable and/or flowable materials containing particles of ultra-hard material, diamond and/or PCBN.
